(19) United States
(12) Patent Application Publication
(10) Pub. No.: US 2011/0133719 A1
(43) Pub. Date: Jun. 9, 2011

(54) Voltage reference circuit operable with a low voltage supply and method for implementing same

(75) Inventors: Alvin Leng Sun Loke, Fort Collins, CO (US); Tin Tin Wee, Fort Collins, CO (US); Chad Owen Lackey, Fort Collins, CO (US); Bruce Andrew Doyle, Longmont, CO (US)

(73) Assignee: Advance Micro Devices, Inc.

(21) Appl. No.: 12/592,891

(22) Filed: Dec. 4, 2009

(51) Int. Cl. G05F 3/16

(52) U.S. Cl. 323/314

(57) ABSTRACT

According to one embodiment, a voltage reference circuit operable with a low voltage supply comprises an op-amp powered by the low voltage supply and a feedback branch including a transistor driven by an output of the op-amp. The feedback branch couples the low voltage supply to ground through the transistor and at least a rectifying device situated between a reference node of the feedback branch and ground. An input of the op-amp is coupled to the reference node by a voltage divider. In one embodiment, the voltage reference circuit further comprises a reference branch coupling a second reference node to ground through at least a second rectifying device, and wherein a second input of the op-amp is coupled to the second reference node by a second voltage divider.

### BACKGROUND OF THE INVENTION

1. Field of the Invention

The present invention is generally in the field of electrical circuits and systems. More specifically, the present invention is in the field of signal processing in electrical circuits and systems.

2. Background Art

Circuits designed to provide accurate reference voltages are widely used in a variety of modern electronic devices and systems. Electronic systems such as data converters, for example, may be especially reliant on a stable well defined voltage reference in order to achieve conversion resolution and range requirements across variations in process technology, as well as supply voltage and temperature (PVT) fluctuations during circuit operation.

Voltage reference circuits capable of providing very stable reference outputs in the is face of PVT variation, such as bandgap voltage reference circuits, have been developed to meet the aforementioned needs. In a typical bandgap voltage reference circuit, temperature-independent behavior can be achieved through the selection and arrangement of circuit elements so as to produce offsetting temperature dependencies within the circuit. When appropriately summed, those offsetting temperature-dependent circuit characteristics can be made to cancel, effectively rendering the voltage reference circuit, as a whole, substantially unaffected by fluctuations in temperature.

As advances in technology are accompanied by reductions in supply voltage, conventional approaches to implementing stable voltage reference circuits such as bandgap references becomes increasingly challenging. For example, supply voltages of 1.1V and lower are now commonly utilized in order to meet the low-power performance and dielectric reliability requirements of some metal-oxide-semiconductor field-effect transistors (MOSFETs). However, MOSFET threshold voltages have not scaled proportionately with reductions in supply voltage due to subthreshold leakage concerns, and the PN junction diodes typically used in bandgap references exhibit forward-bias voltages as high as 0.8V to 0.9V, making it difficult or impossible for conventional voltage reference circuits to operate as designed.

Thus, there is a need to overcome the drawbacks and deficiencies in the art by providing a voltage reference circuit configured to be operable with a low voltage supply.

### SUMMARY OF EMBODIMENTS OF THE INVENTION

A voltage reference circuit operable with a low voltage supply and method for implementing same, substantially as shown in and/or described in connection with at least one of the figures, as set forth more completely in the claims. In one embodiment, such a voltage reference circuit includes an op-amp powered by the low voltage supply and a feedback branch having a transistor driven by an output of the op-amp. The feedback branch couples the low voltage supply to ground through the transistor and at least a rectifying device, such as a diode, situated between a first reference node of the circuit, located in the feedback branch, and ground. The voltage reference circuit can also include a reference branch coupling a second reference node of the circuit to ground through at least a second rectifying device, such as a diode. According to the described embodiment, first and second inputs of the op-amp are coupled, respectively, to the first and second reference nodes by corresponding first and second voltage dividers.

### BRIEF DESCRIPTION OF THE DRAWINGS

FIG. 1 is a diagram showing a conventional voltage reference circuit.

FIG. 2 is a diagram showing a voltage reference circuit operable with a low voltage supply, according to one embodiment of the present invention.

FIG. 3 is a flowchart presenting a method for providing a reference voltage from a low voltage supply, according to one embodiment of the present invention.

FIG. 4 is a diagram showing a voltage reference circuit operable with a low voltage supply, according to another embodiment of the present invention.

### DETAILED DESCRIPTION OF EMBODIMENTS OF THE INVENTION

An embodiment of the present invention is directed to a voltage reference circuit operable with a low voltage supply and method for its implementation.

Although the invention is described with respect to specific embodiments, the principles of the invention, as defined by the claims appended herein, can obviously be applied beyond the specifically described embodiments of the invention described herein. Moreover, in the description of embodiments of the present invention, certain details have been left out in order to not obscure the inventive aspects of the invention. The details left out are within the knowledge of a person of ordinary skill in the art.

The drawings in the present application and their accompanying detailed description are directed to merely example embodiments of the invention. To maintain brevity, other embodiments of the invention, which use the principles of the present invention, are not specifically described in the present application and are not specifically illustrated by the present drawings. It should be borne in mind that, unless noted otherwise, like or corresponding elements among the figures may be indicated by like or corresponding reference numerals. Moreover, the drawings and illustrations in the present application are generally not to scale, and are not intended to correspond to actual relative dimensions.

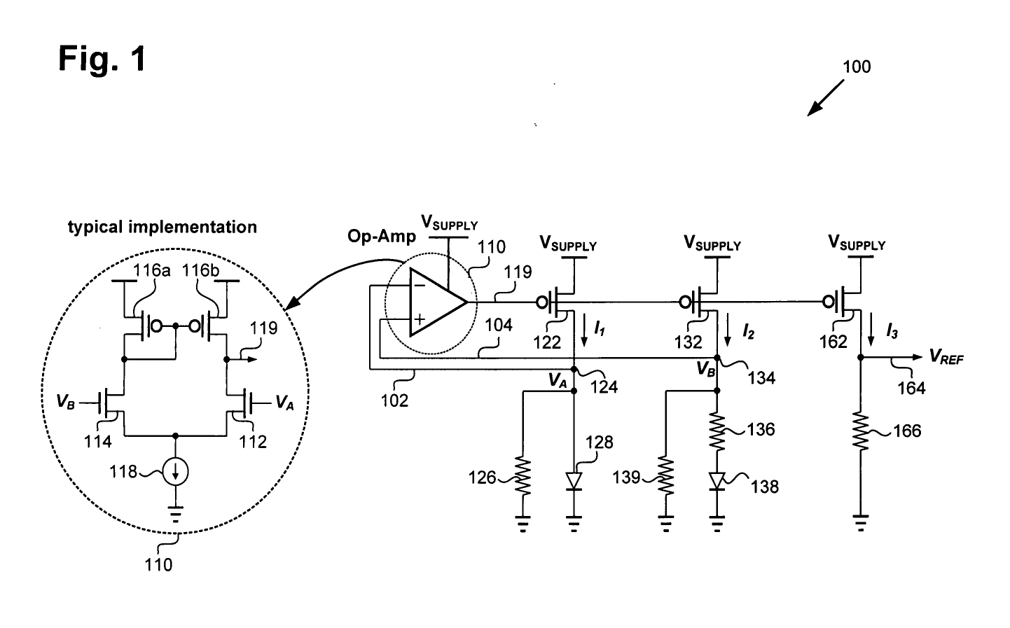

FIG. 1 is a diagram of a conventional bandgap reference circuit designed to provide a stable reference voltage. Conventional circuit 100 includes operational amplifier (op-amp) 110, PMOS transistors 122, 132, and 162 driven by op-amp output 119, resistors 126, 136, 139, and 166, diodes 128 and 138, and reference voltage output 164. As shown in FIG. 1, conventional circuit 100 is implemented with input 102 of op-amp 110 coupled to reference node 124, and input 104 of op-amp 110 coupled to reference node 134. As further shown in FIG. 1, a typical implementation of op-amp 110 includes input NMOS transistors 112 and 114, corresponding respectively to op-amp inputs 102 and 104, PMOS load transistors 116a and 116b, and tail current source 118. Also shown in FIG. 1 is supply voltage V_{SUPPLY} powering op-amp 110 and each of PMOS transistors 122, 132, and 162.

Near temperature independence of conventional circuit 100 can be achieved through appropriate selection of diodes 128 and 138, and resistors 126, 136, 139, and 166. For example, diode 138 is typically selected to be several times larger than diode 128, while resistors 126, 136, 139, and 166 are selected so as to have substantially the same temperature characteristics. The temperature-independent behavior of conventional circuit 100 results from summing of the current through resistor 139 with the current through the combination of resistor 136 and diode 138, to render current I₂ substantially temperature-independent, subject to the substantially similar temperature characteristics of resistors 126, 136, and 139. Current I₂ is then mirrored through output resistor 166 as current I₃, to yield substantially temperature-independent reference voltage output 164.

Thus, the configuration including diodes 128 and 138 and the combination of resistors 126, 136, 139, and 166, or ones similar to it, is important to assure a reliable reference voltage output form conventional circuit 100. However, problems arise because the value of V_{SUPPLY} has become small enough that the forward bias voltages of diodes 128 and 138 now approach the voltages used to supply conventional circuit 100.

In order for conventional circuit 100 to perform as designed, op-amp 110 must produce output 119 such that the voltage V_{A} is very nearly equal to voltage V_{B}. In order for that condition to occur, the gain of op-amp 110 must be as high as possible, meaning that for the implementation shown in FIG. 1, for example, NMOS input transistors 112 and 114, and PMOS load transistors 116a and 116b need to operate in saturation mode. In addition, any transistors comprised by tail current source 118 should be maintained in saturation mode as well. However, as the voltages V_{A} and V_{B} at respective reference nodes 124 and 134 become larger relative to V_{SUPPLY}, it becomes difficult or impossible to maintain the transistors of op-amp 110 in saturation, which, in turn causes the performance of conventional circuit 100 to produce undesirably temperature-dependent reference voltage output 164. As a result, with forward bias voltages for diodes 128 and 138 as high as 0.8V to 0.9V, conventional circuit 100 can be expected to become increasingly inoperable as supply voltages decrease towards 1.0V, for example.

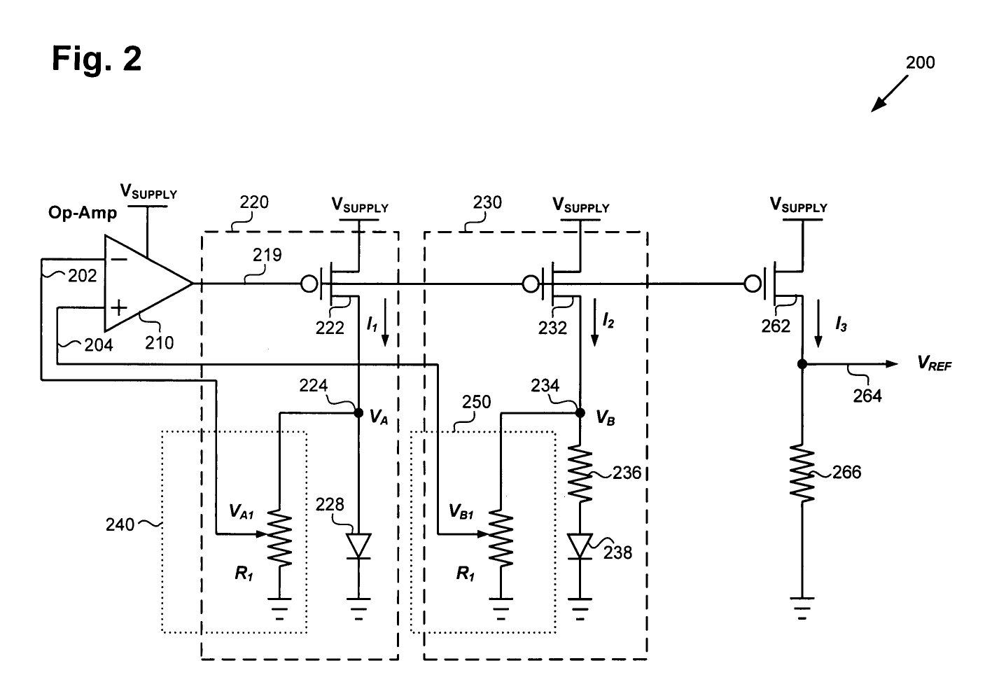

Turning to FIG. 2, FIG. 2 is a diagram showing a voltage reference circuit operable with a low voltage supply, according to one embodiment of the present invention, that succeeds in overcoming the drawbacks and deficiencies of the conventional implementation shown in FIG. 1. Voltage reference circuit 200, in FIG. 2, which is shown having a sub-bandgap configuration, is designed to be operable and stable with supply voltages of less than or substantially equal to approximately 1.0V, for example. Voltage reference circuit 200 is suitable for implementation in an integrated processor, such as by being incorporated as part of an integrated circuit (IC) fabricated on a semiconductor wafer or die.

As shown in FIG. 2, voltage reference circuit 200 comprises op-amp 210 powered by low voltage supply V_{SUPPLY}, feedback branch 220 including voltage divider 240, feedback branch 230 including voltage divider 250, and reference voltage output 264. Op-amp 210 receives inputs 202 and 204, and provides output 219. Op-amp 210 may be implemented using elements substantially similar to the typical implementation of op-amp 110, as shown in FIG. 1, for example. Also shown in FIG. 2 are output transistor 262, implemented as a PMOS device powered by V_{SUPPLY}, and output resistor 266 coupling output transistor 262 to ground.

In addition to voltage divider 250, feedback branch 230 includes transistor 232, shown as a PMOS device driven by output 216 of op-amp 210. As shown in FIG. 2, feedback branch 230 couples low voltage V_{SUPPLY} to ground through transistor 232, resistor 236, and diode 238. Resistor 236 and diode 238 are shown to be situated between reference node 234 of feedback branch 230 and ground. As further shown in FIG. 2, reference node 234, which is characterized by voltage V_{B}, is coupled to input 204 of op-amp 210 by voltage divider 250, which is represented by tapped resistance R₁. As a result, input 204 of op-amp 210 receives a selected fraction of the voltage V_{B} at reference node 234, i.e., V_{B1}. As may be apparent from FIG. 2, the selected fraction of V_{B} provided by voltage divider 250 as V_{B1} corresponds to the position at which resistance R₁ is tapped, wherein the selected fraction increases as the tap position is shifted away from ground.

According to the embodiment shown in FIG. 2, feedback branch 220 includes transistor 222, also shown as a PMOS device driven by output 219 of op-amp 210, in addition to voltage divider 240. As shown in FIG. 2, feedback branch 220 couples low voltage V_{SUPPLY} to ground through transistor 222 and diode 228, which is situated between reference node 224 and ground. Reference node 224, characterized by voltage V_{A}, is coupled to input 202 of op-amp 210 by voltage divider 240, which is also represented by tapped resistance R₁. As a result of the arrangement shown in FIG. 2, input 202 of op-amp 210 receives a fraction of the voltage V_{A} at reference node 224, i.e., V_{A1}, that corresponds to the position at which resistance R₁ is tapped, and where again, the fraction increases as the tap position is shifted away from ground.

It is noted that the circuit elements represented in FIG. 2 are provided as an example implementation of the present inventive principles, and are shown with such specificity for the purposes of conceptual clarity. It should further be understood that particular details such as the number and nature of the transistors in voltage reference circuit 200, their arrangement, as well as other representational features shown in FIG. 2, such as the nature of the rectifying devices characterized as diodes 228 and 238, are being provided as examples, and should not be interpreted as limitations.

For instance, although the embodiment shown in FIG. 2 includes two feedback branches 220 and 230, and three transistors 222, 232, and 262 typically selected to be matching devices, in other embodiments, other arrangements are possible. In one embodiment, for example, a voltage reference circuit according to the present inventive principles may include only one feedback branch, perhaps accompanied by a reference branch, and may be implemented using two matching transistors, rather than the three represented in FIG. 2. In addition, although feedback branches 220 and 230 are shown to comprise respective diodes 228 and 238, such as PN diodes, in other embodiments the functionality of diodes 228 and/or 238 may be performed by other specific components, such as Schottky diodes, or another suitable rectifying device.

Moreover, although voltage dividers 240 and 250 are both shown to include center tapped resistors having substantially the same resistance for simplicity, in practice, voltage dividers 240 and 250 may be implemented with tapping fractions other than 0.5, such as a fraction of 0.6 to 0.7, and/or be implemented using different resistances in place of one or both of resistances R₁, for example. Furthermore, although in one embodiment the selected fraction tapped by voltage divider 250 and the fraction tapped by voltage divider 240 may be substantially the same, in other embodiments the selected fraction of voltage divider 250 and the fraction of voltage divider 240 may be different.

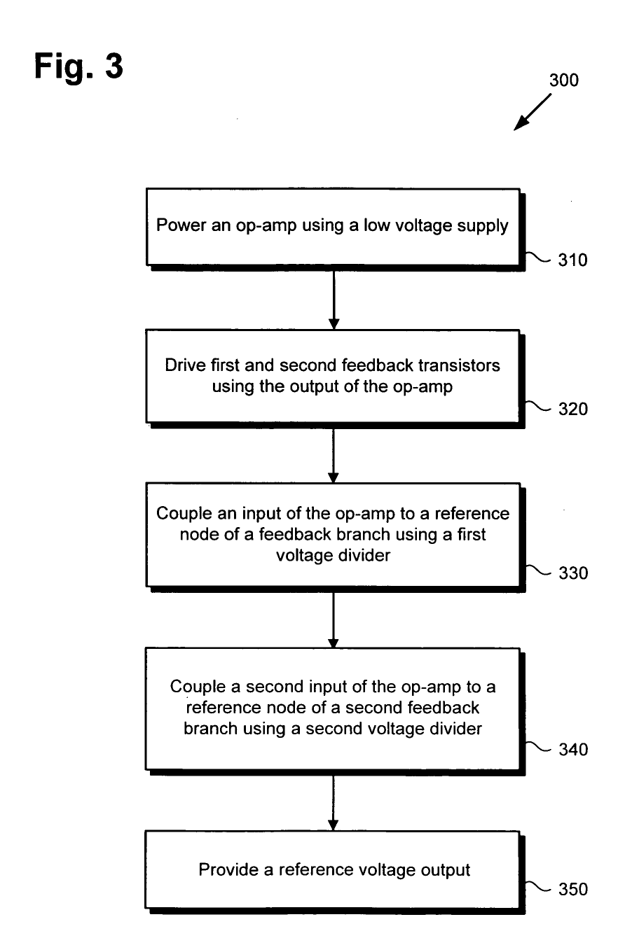

Some of the benefits and advantages accruing from implementation of voltage reference circuit 200 will be further described in combination with flowchart 300, in FIG. 3, which presents an example embodiment of a method for providing a reference voltage from a low voltage supply. Certain details and features have been left out of flowchart 300 that are apparent to a person of ordinary skill in the art. For example, an enumerated operation appearing in flowchart 300 may comprise one or more additional operations or may involve specialized equipment or materials, as known in the art. While operations 310 through 350 indicated in flowchart 300 are sufficient to describe one embodiment of the present invention, other embodiments of the present invention may utilize operations different from those shown in flowchart 300, or may comprise more, or fewer, operations.

Referring to operation 310 in FIG. 3 in view of voltage reference circuit 200, in FIG. 2, operation 310 of flowchart 300 comprises powering op-amp 210 using low voltage supply V_{SUPPLY}. As previously mentioned, V_{SUPPLY} may represent a voltage of less than or substantially equal to as little as approximately 1.0V, for example. As a result, operation 310 corresponds to powering op-amp 210 of voltage reference circuit 200 with a supply voltage that may only slightly exceed the forward bias voltage of diodes 228 and 238, for example.

Continuing with operation 320 in FIG. 3 and continuing to refer to reference voltage circuit 200, in FIG. 2, operation 320 of flowchart 300 comprises driving transistors 232 and 222 of respective feedback branches 230 and 220 using output 219 of op-amp 210. As previously explained in conjunction with FIG. 2, feedback branch 230 couples low voltage V_{SUPPLY} to ground through transistor 232, resistor 236, and diode 238, and includes reference node 234 situated between transistor 232 and the series combination of resistor 236 and diode 238.

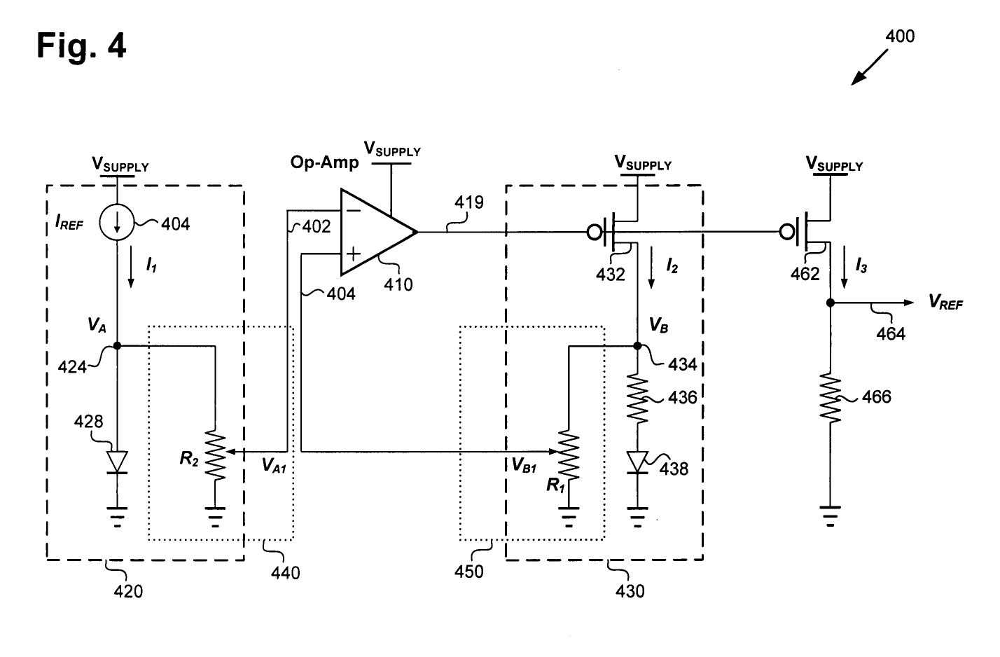

According to the present embodiment, voltage reference circuit 200 includes feedback branch 220 coupling low voltage V_{SUPPLY} to ground through transistor 222 and diode 228, and having reference node 224 situated between transistor 222 and diode 228. It is noted, however, that more generally, a voltage reference circuit according to the present inventive concepts may comprise a single feedback branch, such as feedback branch 230, in combination with a reference branch (represented by feedback branch 220) in voltage reference circuit 200. Thus, in the more general case, operation 320 can correspond to driving a single feedback transistor, such as transistor 232, and concurrently providing a reference current I₁ other than by the arrangement shown as feedback branch 220. One alternative embodiment including a single feedback branch in combination with a reference branch is shown and described in greater detail by reference to FIG. 4 below.

Moving on to operation 330 of FIG. 3, and continuing to focus on the circuit embodiment shown in FIG. 2, operation 330 of flowchart 300 comprises coupling input 204 of op-amp 210 to reference node 234 of feedback branch 230, using voltage divider 250. Reference node 234 is characterized by voltage V_{B}, which corresponds to the voltage across the series combination of resistor 236 and diode 238. As shown in FIG. 2, reference node 234 is coupled to input 204 of op-amp 210 by voltage divider 250, which is represented by tapped resistance R₁ in the embodiment of voltage reference circuit 200. As a result, input 204 of op-amp 210 receives a selected fraction of the voltage V_{B} at reference node 234.

Continuing with operation 340 of flowchart 300, operation 340 comprises coupling input 202 of op-amp 210 to reference node 224 of feedback branch 220 using voltage divider 240. Reference node 224 is characterized by voltage V_{A}, which corresponds to the forward bias voltage of diode 228. As shown in FIG. 2, according to the present embodiment, reference node 224 is coupled to input 204 of op-amp 210 by tapped resistance R₁ of voltage divider 240. As a result, input 202 of op-amp 210 receives a fraction of the voltage V_{A} at reference node 224.

Referring to operation 350 of flowchart 300, operation 350 comprises providing reference voltage output 264. As shown in FIG. 2, in one embodiment, op-amp 210 is powered by low voltage V_{SUPPLY}, receives inputs from feedback branches 230 and 220 through respective voltage dividers 250 and 240, and produces output 219, which is used to drive output transistor 262. As a result of operations 310 through 350, voltage reference circuit 200 provides a stable and reliable reference voltage output 262 despite receiving low voltage supply V_{SUPPLY}.

Turning to FIG. 4, FIG. 4 is a diagram showing voltage reference circuit 400 operable with a low voltage supply, according to another embodiment of the present invention. Voltage reference circuit 400, which is shown having a pseudo-bandgap configuration, is designed to be operable and stable with supply voltages of less than or substantially equal to approximately 1.0V, for example. As was the case for the embodiment of the present invention shown in FIG. 2, voltage reference circuit 400, in FIG. 4, is suitable for implementation in an integrated processor, such as by being incorporated as part of an integrated circuit (IC) fabricated on a semiconductor wafer or die, for example.

Voltage reference circuit 400 comprises op-amp 410 powered by low voltage supply V_{SUPPLY} and having inputs 402 and 404, reference branch 420 including voltage divider 440, feedback branch 430 including voltage divider 450, and reference voltage output 464. Op-amp 410 powered by low voltage V_{SUPPLY}, op-amp inputs 402 and 404, feedback branch 430 including voltage divider 450, and reference voltage output 464 correspond respectively to op-amp 210 powered by low voltage supply V_{SUPPLY}, op-amp inputs 202 and 204, feedback branch 230 including voltage divider 250, and reference voltage output 264, in FIG. 2. Also shown in FIG. 4 are output transistor 462 and output resistor 466 corresponding respectively to output transistor 262 and output resistor 266, in FIG. 2.

As shown in FIG. 4, feedback branch 430 includes transistor 432, resistor 436, diode 438, and reference node 434 situated between transistor 432 and the series combination of resistor 436 and diode 438. Transistor 432, reference node 434, resistor 436, and diode 438 correspond respectively to transistor 232, reference node 234, resistor 236, and diode 238, in FIG. 2. As further shown in FIG. 4, reference node 434 is coupled to input 404 of op-amp 410 by voltage divider 450, which is represented by tapped resistance R₁. As a result, input 404 of op-amp 410 receives a selected fraction of the voltage V_{B} at reference node 434, i.e., V_{B1}.

According to the embodiment shown in FIG. 4, voltage reference circuit 400 includes reference branch 420 as a substitute for feedback branch 220 in the circuit of FIG. 2. As shown in FIG. 4, reference branch 420 includes current source 404 providing reference current I₁, diode 428, and reference node 424 coupling current source 404 to ground through diode 428. Reference node 424, characterized by voltage V_{A}, is also coupled to input 402 of op-amp 410 by voltage divider 440, which is represented by tapped resistance R₂. Resistance R₂ of voltage divider 440 may have a different resistance value from that of resistance R₁ in voltage divider 450. In practice, resistance R₂ is likely to have a substantially greater resistance value than resistance R₁, such as a resistance value of three hundred percent, or more, that of resistance R₁, for example.

As a result of the arrangement shown in FIG. 4, input 402 of op-amp 410 receives a fraction of the voltage V_{A} at reference node 424, i.e., V_{A1}, that corresponds to the position at which resistance R₂ is tapped, and where, as is the case for resistance R₁, the fraction provided to op-amp 410 increases as the tap position is shifted away from ground.

It is noted that although voltage dividers 440 and 450 are both shown to include center tapped resistors, in other embodiments, voltage dividers 440 and 450 may be implemented with tapping fractions other than 0.5, such as a fraction of 0.6 to 0.7, for example. Moreover, although feedback branch 430 and reference branch 420 are shown to comprise respective diodes 438 and 428, such as PN diodes, in other embodiments the functionality of diodes 428 and/or 438 may be performed by other specific components, such as Schottky diodes, or other suitable rectifying devices.

One implementational advantage of the pseudo-bandgap circuit embodiment shown in FIG. 4, is the reduced use of matching transistors. For example, due to variances in the manufacturing process, transistors designed to display substantially identical operational profiles, such as transistors 222, 232, and 262, in FIG. 2, and transistors 432 and 436, in FIG. 4, for example, may in fact perform differently. Because the implementation represented by voltage reference circuit 400 uses fewer transistors, e.g., two transistors, rather than the three utilized in voltage reference circuit 200, the likelihood of performance anomalies resulting from device mismatch is reduced.

In some embodiments, a voltage reference circuit operable with a low voltage supply, such as sub-bandgap voltage reference circuit 200, in FIG. 2, or pseudo-bandgap voltage reference circuit 400, in FIG. 4, may be produced according to instructions stored on a computer-readable medium. For example, instructions adapted for use in configuring aspects of a manufacturing process to fabricate a voltage reference circuit, such as hardware description language (HDL) instructions, for instance, may be stored on a computer-readable medium. Execution of those instructions in the course of a fabrication process can result in production of a voltage reference circuit operable with a low voltage supply. As previously explained, the voltage reference circuit may comprise an op-amp powered by the low voltage supply, a feedback branch including a transistor driven by an output of the op-amp, the feedback branch coupling the low voltage supply to ground through the transistor and at least a rectifying device situated between a reference node of the feedback branch and ground, wherein an input of the op-amp is coupled to the reference node by a voltage divider. The expression “computer-readable medium,” as used in the present application, refers to any medium that stores instructions usable by a system for fabricating an IC.

Thus, a computer-readable medium may correspond to various types of media, such as volatile media, non-volatile media, and transmission media, for example. Volatile media may include dynamic memory, such as dynamic random-access memory (RAM), while non-volatile memory may include optical, magnetic, or electrostatic storage devices. Transmission media may include coaxial cable, copper wire, or fiber optics, for example, or may take the form of acoustic or electromagnetic waves, such as those generated through radio frequency (RF) and infrared (IR) communications. Common forms of computer-readable media include, for example, a RAM, programmable read-only memory (PROM), erasable PROM (EPROM), and FLASH memory.

Thus, the present application discloses embodiments of a voltage reference circuit operable with a low voltage supply, as well as a method for its implementation. By introducing voltage dividers to selectively control the voltages provided as inputs to an op-amp powered by the low voltage supply, the present solution advantageously enables maintenance of the op-amp in a high gain operational mode. As a result, the disclosed solution is configured to provide a stable well defined voltage reference even when used with a supply voltage of approximately 1.0V or less.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. The described embodiments are to be considered in all respects as illustrative and not restrictive. It should also be understood that the invention is not limited to the particular embodiments described herein, but is capable of many rearrangements, modifications, and substitutions without departing from the scope of the invention.

1. A voltage reference circuit operable with a low voltage supply, said voltage reference circuit comprising:
an op-amp powered by said low voltage supply;
a feedback branch including a transistor driven by an output of said op-amp, said feedback branch coupling said low voltage supply to ground through said transistor and at least a rectifying device situated between a reference node of said feedback branch and ground;
an input of said op-amp coupled to said reference node by a voltage divider.

2. The voltage reference circuit of claim 1, wherein said input of said op-amp receives a selected fraction of the voltage at said reference node.

3. The voltage reference circuit of claim 1, wherein said low voltage supply comprises a voltage of less than or equal to approximately 1.0V.

4. The voltage reference circuit of claim 1, wherein said rectifying device comprises a diode.

5. The voltage reference circuit of claim 1, further comprising:
a reference branch coupling a second reference node to ground through at least a second rectifying device;
a second input of said op-amp coupled to said second reference node by a second voltage divider.

6. The voltage reference circuit of claim 5, wherein said second input of said op-amp receives a fraction of the voltage at said second reference node.

7. The voltage reference circuit of claim 6, wherein said selected fraction of said voltage at said reference node and said fraction of the voltage at said second reference node comprise substantially the same fraction.

8. The voltage reference circuit of claim 5, wherein said second reference node couples a reference current source of said reference branch to ground through said second rectifying device.

9. The voltage reference circuit of claim 5, wherein said reference branch is a second feedback branch comprising a second transistor driven by said output of said op-amp, said second feedback branch coupling said low voltage supply to ground through said second transistor and at least said second rectifying device.

10. The voltage reference circuit of claim 5, wherein said second rectifying device comprises a diode.

11. A computer-readable medium having stored thereon instructions for fabricating a voltage reference circuit operable with a low voltage supply, said voltage reference circuit comprising:
an op-amp powered by said low voltage supply;
a feedback branch including a transistor driven by an output of said op-amp, said feedback branch coupling said low voltage supply to ground through said transistor and at least a rectifying device situated between a reference node of said feedback branch and ground;
an input of said op-amp coupled to said reference node by a voltage divider.

12. The computer-readable medium of claim 11, wherein said instructions for fabricating said voltage reference circuit comprise hardware description language (HDL) instructions.

13. The computer-readable medium of claim 11, wherein said voltage reference circuit further comprises:
a reference branch coupling a second reference node to ground through at least a second rectifying device;
a second input of said op-amp coupled to said second reference node by a second voltage divider.

14. A method for providing a reference voltage from a low voltage supply, said method comprising:
powering an op-amp using said low voltage supply;
driving a transistor using an output of said op-amp, said transistor coupling said low voltage supply to ground through at least a rectifying device situated between a reference node and ground;
coupling an input of said op-amp to said reference node by a voltage divider.

15. The method of claim 14, wherein coupling said input of said op-amp to said reference node by said voltage divider results in said input of said op-amp receiving a selected fraction of the voltage at said reference node.

16. The method of claim 14, wherein said low voltage supply comprises a voltage of less than or equal to approximately 1.0V.

17. The method of claim 14, further comprising:
producing a comparison voltage at a second reference node of said voltage reference circuit; and
coupling a second input of said op-amp to said second reference node by a second voltage divider.

18. The method of claim 17, wherein coupling said second input of said op-amp to said second reference node by said second voltage divider results in said second input of said op-amp receiving a fraction of said comparison voltage.

19. The method of claim 18, wherein said selected fraction of said voltage at said reference node and said fraction of said comparison voltage comprise substantially the same fraction.

20. The method of claim 17, wherein producing said comparison voltage comprises driving a second transistor using said output of said op-amp, said second transistor coupling said low voltage supply to ground through at least a second rectifying device situated between said second reference node and ground.
